(19) United States
(12) Patent Application Publication
(10) Pub. No.: US 2012/0139231 A1
(43) Pub. Date: Jun. 7, 2012

(54) Healthcare Form Assembly Having a Plurality of Removable Strips with Fingerlift Feature

(75) Inventors: Anne M. DEHLINGER, North Tonawanda, NY (US); Michael J. MOORE, Ameila Island, FL (US); William BECKER, Lockport, NY (US)

(73) Assignee: AVERY DENNISON CORPORATION, Pasadena, CA (US)

(21) Appl. No.: 13/270,631

(22) Filed: Oct. 11, 2011

Related U.S. Application Data
(63) Continuation-in-part of application No. 13/021,873, filed on Feb. 7, 2011.
(60) Provisional application No. 61/302,593, filed on Feb. 9, 2010.

(51) Int. Cl. B42D 15/00

(52) U.S. Cl. 283/75

(57) ABSTRACT

A healthcare form assembly is described which includes a carrier sheet, a release coating applied to the carrier sheet, one or more regions of pressure sensitive adhesive adjacent the release coating, and a printable sheet in contact with the adhesive and being removably disposed on the carrier sheet. The printable sheet includes a collection of cut lines to thereby form adhesive strips which can be readily removed from the carrier sheet. Particular features such as peel zones and fingerlifts are also described.

### CROSS-REFERENCE TO RELATED APPLICATION

The present application is a Continuation-In-Part of U.S. patent application Ser. No. 13/021,873 filed Feb. 7, 2011, which claims the benefit of U.S. Provisional Application No. 61/302,593 filed Feb. 9, 2010, both of which are incorporated herein by reference in their entireties.

### FIELD OF THE INVENTION

The present invention relates to a sheet assembly for use in providing a number of removable pre-cut adhesive strips for use in the healthcare field.

### BACKGROUND OF THE INVENTION

The treatment of individuals in various healthcare related environments typically requires the use of a wide variety of medical devices, appliances, pharmaceuticals and other treatments. In order to reduce the possible spread of disease or contamination of the surgical or treatment theaters, typically, devices are not reused and must be disposed of once the patient or individual has been treated.

Certain treatment devices, such as IV bags, oxygen and nutritional supply tubes, catheters, monitoring device feed lines and the like require that the device be removably attached to the patient or the individual. Commonly, a piece of tape, which is often supplied from a roll, is torn from the roll supply and then applied to the tube, line or other device to secure the device to the patient. In an effort to reduce possible contamination, the remaining portion of the roll of tape is typically discarded leading to additional waste and cost in the care facility. When multiple tape sizes are required to hold or secure different appliances to the patient, then different sized rolls of tape are needed, which as noted are discarded after exposure to the treatment theater, thereby leading to additional waste and expense.

In addition, removal of tape from a tape source by a healthcare provider can also be difficult, particularly if the provider is wearing surgical or latex gloves. Typically, the leading edge of the tape is difficult to grasp by the hand or fingers of the provider due to the nature of the glove that the provider may be wearing.

What is needed therefore is an inexpensive delivery system by which a plurality of removable strips can be delivered to a treatment theater, and which strips can be easily removed and applied when needed.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to a healthcare treatment form assembly that is suitable for use in a patient treatment theater to secure treatment appliances to an individual. The form assembly includes a laminated, pressure sensitive assembly having a plurality of uniquely sized strips that can be easily removed and applied to a patient by a care giver.

In one exemplary embodiment of the presently described invention, a healthcare form assembly is presented and includes a quadrate carrier sheet having first and second edges and first and second longitudinally extending sides. The quadrate sheet has top and bottom face surfaces.

A release coating is applied substantially over the top face surface of the quadrate carrier sheet. And a pattern of adhesive is applied over the release coating on the top surface of the quadrate sheet to create at least first and second adhesive areas spaced from one another in which each adhesive area has a first boundary and an opposite second boundary. First and second peel zones are provided along at least the first boundary of each of the first and second adhesive areas.

Continuing with a discussion of the presently described embodiment, a quadrate printable sheet is juxtaposed substantially entirely over the quadrate carrier sheet. The quadrate printable sheet is provided with a plurality of cut lines running substantially parallel to the first and second longitudinally extending sides of the quadrate carrier sheet to form a series of removable strips over each of the first and second adhesive areas.

A plurality of transversely extending cut lines extends substantially parallel to the first and second edges of the quadrate carrier sheet. Specifically, a first set of cut lines define a first peel zone along the first boundary of the first adhesive area and a second set of transversely extending cut lines define a second peel zone along the first boundary of the second adhesive area.

In a further exemplary embodiment of the presently described invention, a pressure sensitive laminate assembly for use in securing medical appliances is described and includes a first sheet that has top and bottom faces, first and second ends and first and second sides. A release coating is applied over the top face of the first sheet and a pattern of pressure sensitive adhesive is applied over the release coating on the top face of the first sheet. The adhesive pattern defines at least two adhesive free areas separated by regions of adhesive.

Continuing with a description of the presently described embodiment, a second sheet is applied over the pattern of pressure sensitive adhesive. The second sheet is provided with a plurality of longitudinally extending cuts and a series of transversely extending cuts running substantially perpendicular to the longitudinally extending cuts. The plurality of longitudinally extending cuts defines a series of first and second removable strips having at least first and second dimensions. The first strip has a first width and length and the second strip has a second width less than the first width and a length.

The series of transversely extending cuts defines first and second peel zones which overlie and are generally aligned with the adhesive free areas, with the first adhesive free area defining a leading edge of a first area of strips and the second adhesive free area defining a leading edge of a second area of strips. The first and second areas of strips are substantially equal in area.

In another exemplary embodiment, a healthcare form assembly includes a carrier sheet including a leading edge and a trailing edge that are opposite one another, a release coating disposed on the carrier sheet, and an adhesive layer disposed on the release coating. The healthcare form assembly also includes a printable sheet having a same or substantially the same shape as the carrier sheet and being removably disposed on the carrier sheet. The printable sheet includes a leading edge and a trailing edge that are opposite one another and oriented on the carrier sheet such that the trailing edge of the printable sheet is intimately disposed next to the trailing edge of the carrier sheet. The printable sheet defines a first set of cut lines. The printable sheet also defines another set of transversely extending cut lines extending substantially parallel to the leading edge of the printable sheet to create a first peel zone along the leading edge of the printable sheet. Optionally, the printable sheet can also define additional sets of cut lines extending substantially parallel to the leading edge of the printable sheet and spaced from the first peel zone to create additional peel zone(s). A strip or section of a layer of a deadening material is disposed in one or more of the peel zones between the release coating and the adhesive layer.

In yet another exemplary embodiment, a healthcare form assembly includes a carrier sheet including a leading edge and a trailing edge that are generally parallel to one another and a first side edge and a second side edge that are generally perpendicular to the leading edge. A distance between the leading edge and the trailing edge defines a carrier sheet length and a distance between the first side edge and the second side edge defines a carrier sheet width. Preferably, the sheet length is greater than the carrier sheet width. The healthcare form assembly also includes a release coating disposed on the carrier sheet, and an adhesive layer disposed on the release coating. The healthcare form assembly also includes a printable sheet releasably disposed on the carrier sheet. The printable sheet includes a leading edge and a trailing edge that are generally parallel to one another and a first side edge and a second side edge that are generally perpendicular to the leading edge of the printable sheet. A distance between the leading edge of the printable sheet and the trailing edge of the printable sheet defines a printable sheet length and a distance between the first side edge of the printable sheet and the second side edge of the printable sheet defines a printable sheet width. Preferably, the printable sheet length is greater than the printable sheet width. The printable sheet defines a collection of cut lines extending substantially parallel to one of the first side edge and the second side edge. This collection of cut lines defines a plurality of removable adhesive strips. The printable sheet also defines a first set of cut lines extending substantially parallel to the leading edge of the printable sheet to create a first peel zone along the leading edge of the printable sheet and a second set of cut lines extending substantially parallel to the leading edge of the printable sheet to create a second peel zone which is spaced from the first peel zone. A strip or section of a layer of a deadening material is disposed in one or more of the peel zones. Regarding the first peel zone, in an optional aspect, at least one of the strip of deadening material and/or a portion of the printable sheet extends beyond the leading edge of the carrier sheet. The second peel zone can include a bisecting cut line in the printable sheet to promote separation of removable strips on either side of the second peel zone.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top planar view of a preferred embodiment healthcare form assembly including central and peripheral peel zones according to the presently described invention;

FIG. 2 is a cross sectional view of the healthcare form assembly shown in FIG. 1 taken across line 2-2;

FIG. 3 illustrates an alternate configuration of the healthcare form assembly in which a central peel zone and two peripheral peel zones are provided with a plurality of finger lifts;

FIG. 4 shows removal of a removable strip from the healthcare form assembly depicted in FIG. 1;

FIG. 5 illustrates an exemplary use of a collection of removable strips from the healthcare form assembly;

FIG. 6 is an exploded view of another preferred embodiment of the healthcare form assembly of the presently described invention having a plurality of peel zones and fingerlifts;

FIG. 7 is a top plan view of the healthcare form assembly depicted in FIG. 6;

FIG. 8 is a cross sectional view of the healthcare form assembly depicted in FIG. 7 taken along line 8-8;

FIG. 9 is a cross sectional view of another preferred embodiment of the healthcare form assembly of the presently described invention having central and peripheral peel zones with fingerlifts;

FIG. 10 is a cross sectional view of yet another preferred embodiment of the healthcare form assembly of the presently described invention with central and peripheral peel zones and fingerlifts; and

FIG. 11 is a cross sectional view of a still another preferred embodiment of the healthcare form assembly of the presently described invention having a peripheral peel zone and fingerlift.

### DETAILED DESCRIPTION OF THE EMBODIMENTS

The various assemblies, components, and methods disclosed in this document are described in detail by way of examples and with reference to the figures. Unless otherwise specified, like numbers in the figures indicate references to the same, similar, or corresponding elements throughout the figures. An example of like numbers are numbers such as 34 and 134, or other numbers in a different hundred series. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such.

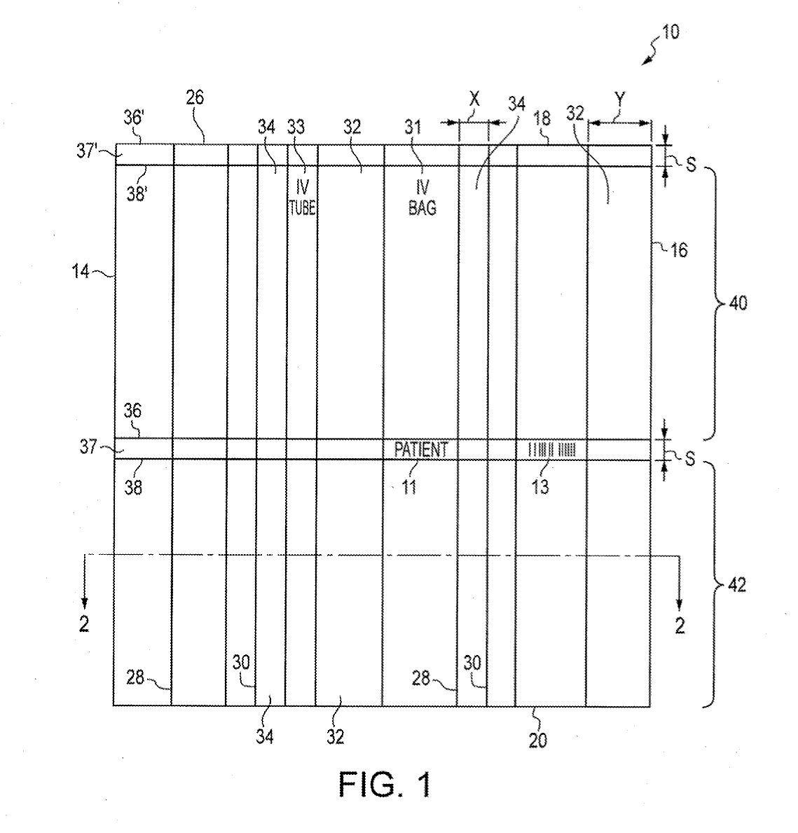

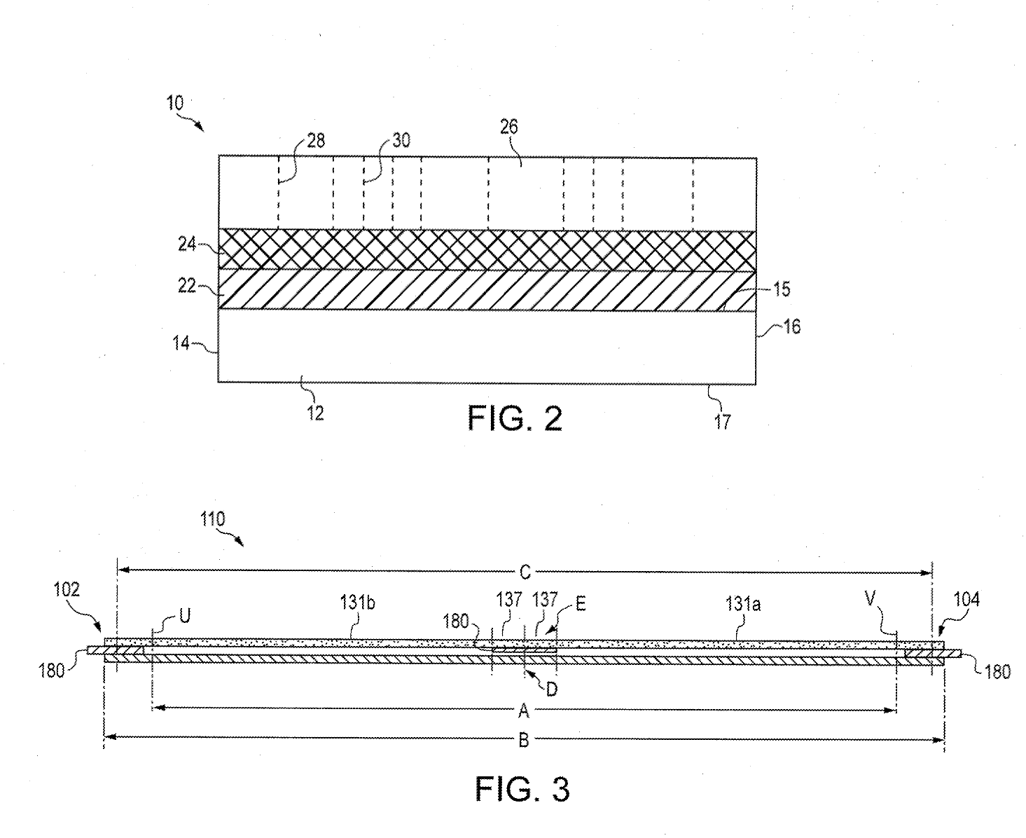

Reference is now directed to FIGS. 1 and 2 in which a preferred embodiment healthcare form assembly is generally depicted by reference to numeral 10. The preferred embodiment healthcare form assembly includes a quadrate carrier sheet 12 that has first and second longitudinally extending sides 14, 16 and first and second transversely extending end edges 18, 20. The quadrate carrier sheet 12 has top and bottom face surfaces 15, 17, see FIG. 2. A release coating 22 is applied over the top face surface 15 of the quadrate sheet 12. The release coating 22 is preferably a silicone based coating. A pattern of pressure sensitive adhesive 24 is applied over the release coating 22. Preferably, the adhesive is deposited as a layer and defines at least two adhesive areas such as adhesive areas 40 and 42, which are spaced apart from one another. However, the adhesive layer may be a relatively continuous layer. Additional details concerning the adhesive layer and particularly the adhesive areas 40, 42 are provided herein. A quadrate printable sheet 26 is applied over the adhesive 24.

The printable sheet 26 is provided with a plurality of longitudinally extending cut lines such as 28, 30 which run parallel to the first and second longitudinally extending sides 14 and 16. The cut lines 28, 30 section or divide the sheet 26 into individual removable strips such as strips 32, 34, which release from the assembly with adhesive on the back side of the strips. The strips have a length and a width, with the length of the strips 32, 34 being substantially equal and the width of at least some of the strips being different. For example, the length of the strips 32, 34 may be about 133 mm (about 5.25 inches) in length and the width of strip 32 is about 25 mm (about 1.0 inch), while the width of the strip 34 is about 13 mm (about 0.5 inches). It will be appreciated however that the invention is not limited to these particular dimensions. For example, the length of the strips may be from about 300 mm (about 12 inches) or longer to about 25 mm (about 1 inch) or less, and typically from about 200 mm (about 8 inches) to about 50 mm (about 2 inches) in length. Furthermore, a relatively wide strip may have a width of from about 100 mm (about 4 inches) or more to about 13 mm (about 0.5 inch) or less, and typically from about 50 mm (about 2 inches) to about 20 mm (about 0.75 inch) in width. This width dimension is illustrated in FIG. 1 as dimension Y. A relatively thin strip may have a width of from about 75 mm (about 3 inches) or more to about 2.5 mm (about 0.1 inch) or less, and typically from about 25 mm (about 1 inch) to about 6 mm (about 0.25 inch) in width. This width dimension is illustrated in FIG. 1 as dimension X. Furthermore, the invention includes healthcare sheet assemblies having a plurality of removable adhesive strips all having the same width. In addition, it is also contemplated that the invention includes healthcare sheet assemblies having a plurality of removable adhesive strips which have the same width yet which differ in length. And, the invention includes healthcare sheet assemblies having a plurality of removable adhesive strips which have different widths and different lengths.

The printable or top sheet 26 is also provided with a plurality of transversely extending cut lines 36, 38 and 36′, 38′ (see FIG. 1) which run perpendicular to the first and second longitudinally extending sides 14, 16 and parallel to the first and second ends 18, 20. The transversely extending cut lines 36, 38 are generally located along one or both of the first and second adhesive areas 40, 42. The transversely extending cut lines 36′, 38′ are generally located along a peripheral edge, such as first end 18. The space or distance between the transversely extending cut lines 36, 38 and 36′, 38′ is illustrated in FIG. 1 as distance S. Distance S typically ranges from about 25 mm (about 1 inch) or more to about 2.5 mm (about 0.1 inch) or less and is preferably about 6 mm (about 0.25 inches). The distance S between the transversely extending cut lines 36, 38 and 36′, 38′ creates peel zones 37, 37′ which facilitate the removal of the strips 32, 34 from the assembly 10.

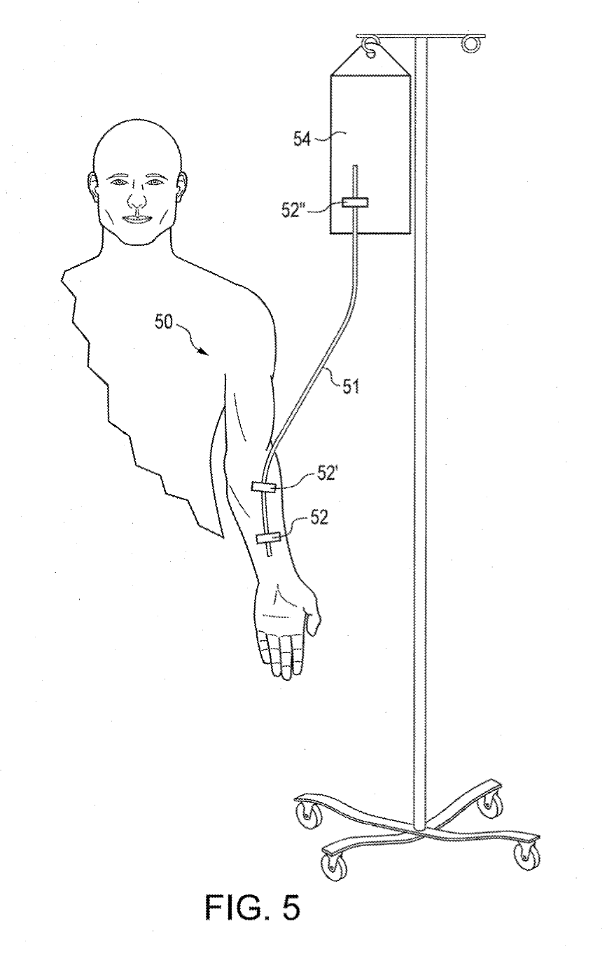

The printable sheet 26 may be provided with indicia on one or more strips such as strips 33, 31 to assist the care provider in selecting the appropriate strips for use in treating the patient. For example, strip 31 may be used to attach a tube (see FIG. 5) to an IV bag whereas strip 33 may be used to attach an IV tube to a patient's arm. Other information can be provided on the printable sheet 26, such as patient indicia and bar codes 11 and 13 respectively, or other hospital information.

The peel zones 37, 37′ of the preferred embodiment assembly 10, are preferably areas that are free of adhesive. That is, during the pattern coating of the adhesive 24, no adhesive is provided in the areas of the peel zones, thereby creating an adhesive free area. Preferably, as noted, the layer of pressure sensitive adhesive 24 is deposited so as to form a first adhesive area 40 and a second adhesive area 42, which are most preferably equal in surface area. In the embodiment illustrated in FIG. 1, the adhesive free area is preferably about 6 mm (about 0.25 inches) wide (distance S) by about 216 mm (about 8.5 inches) long. However, it will be appreciated that the invention includes health care form assemblies with zones having a wide range of dimensions and corresponding areas. In another embodiment, the peel zones have a width of from about 5 mm (about 0.2 inch) to about 15 mm (about 0.6 inch), and preferably from about 10 mm (0.40 inch) to about 12 mm (about 0.48 inch). It is also contemplated that the peel zones can be configured such that they are unequal in dimensions or area. For example, the peel zone 37 may have a width of about 10 mm and the peel zone 37′ may have a width of about 12 mm. Again, it will be appreciated that in no way is the invention limited to any of these particular dimensions. Alternatively, if adhesive is provided within a peel zone, it is deadened, such as by corona treating so that the adhesive does not create any tension when removing the strips, such as strips 32, 34 for example. In the embodiment under discussion, the first peel zone 37′ receives the leading edge of strips defined in the first adhesive area 40 while the second peel zone 37 receives the leading edge of strips defined in the second adhesive area 42. The peel zones 37 and 37′ preferably have a perforated cut through one or more edges to further promote easy separation of one or more strips from the carrier sheet of the form.

Referring again to FIG. 1, each of the first and second adhesive areas 40 and 42 preferably have an equal number of strips 32, 34 which are similarly dimensioned. That is, preferably, the number of strips extending within each of the adhesive areas 40, 42 is the same. For example in the embodiment under discussion, the strips all have a length of about 133 mm (about 5.25 inches) and widths of about 13 mm (about 0.50 inch) and 26 mm (about 1.00 inch). As noted, it will be appreciated that the invention is not limited to any particular size or dimensions. And so, the various strips may be provided in nearly any size, shape, configuration, or area.

In another preferred embodiment as shown in FIG. 3, a healthcare form assembly 110 is provided with a plurality of removable strips. In this embodiment, the assembly 110 includes three peel zones. Two peel zones are disposed along two peripheral or edge regions of the assembly. Another centrally located peel zone is provided between the two peripheral peel zones. In order to further promote separation of a strip from the carrier sheet at a peel zone, a strip or section of material 180 generally referred to herein as a deadening material is disposed within one or more peel zones of interest. These and other aspects are all described in greater detail herein.

In certain applications, it may be preferable to provide a centrally disposed peel zone and preferably one including a layer of deadening material within the peel zone. A centrally disposed peel zone provides another region at which one or more removable strips can be removed from the carrier. Specifically, in the preferred embodiment 110 depicted in FIG. 3, the length of the healthcare form assembly is illustrated as C which is about 320 mm (about 12.6 inches) with a central peel zone illustrated as E which is about 25 mm (about 1 inch), which is separated into two portions 137 of about 12 mm (0.5 inch) each. In this way, two strips extending across the length of the form and separated by the central peel zone E can be removed in an opposite direction from one another. Thus by bending the form about its midsection, the deadening material 180 in central peel zone E can be easily exposed to enable removal of the strips from the form. Preferably, a perforation or cut shown as D in FIG. 3 is provided to assist in separating two strips 131a and 131b from each other at the middle of the central peel zone area. FIG. 3 also illustrates dimension A which is the distance between a pair of perforations or cut lines shown as U and V which provide for tear off peel tabs. Dimension B is the length of the form assembly 110 prior to trimming edge regions 102 and 104, to produce the form having length C.

In forming the preferred embodiment healthcare sheet assemblies, and particularly those having one or more peel zones located along a peripheral edge, it may be preferred to perform a trimming operation along the peripheral edge to obtain a “clean” edge in which the edges of the carrier sheet and the printable sheet overlie one another and are generally aligned. Trimming one or more peripheral edges may also be preferred for peripheral peel zones that include a strip of deadening material. Again, in certain embodiments it may be preferred to provide a clean peripheral edge.

However, the present invention also includes embodiments in which a peripheral peel zone includes one or more layers that extend outward or beyond the edge of the underlying carrier sheet. Such outwardly extending regions are referred to herein as fingerlifts and promote grasping of a removable strip and separation of the strip from the carrier. Details as to the fingerlifts are described in conjunction with other preferred embodiment healthcare sheet assemblies.

Regarding the fingerlifts, in certain embodiments one or more strips or sections of deadening material can be provided partially or entirely within a peel zone, in less than all peel zones, or in all peel zones. As noted, the incorporation of deadening material may further promote ease of separation and removal of an adhesive strip from a healthcare sheet assembly. The deadening material strips can be provided in a wide array of shapes and sizes. For example, referring further to FIG. 3, the length of the deadening material strip is about 10 mm (about 0.40 inch), and the removable strip such as strip either strip 131a or 131b, has a length dimension of about 160 mm (about 6.3 inches) and a final tape length of 148 mm (160 mm with the 12 mm finger lift strip removed). The strip and the deadening material have a width of about 24 mm (about 0.95 inch).

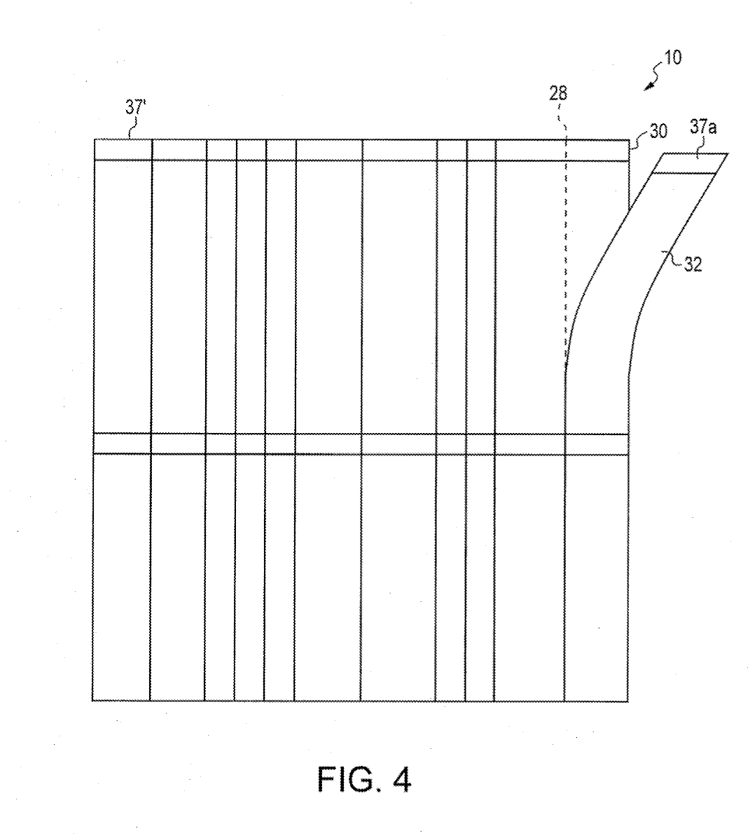

FIG. 4 illustrates the previously described healthcare assembly 10 and peeling away of one removable strip 32 through use of a peel tab 37a. The peel tab 37a is the region of the strip 32 which overlies the peel zone 37′. Preferably, the peel zone 37′ is free of adhesive or if adhesive is disposed within the peel zone 37′, the adhesive within that region is deadened. The peel tab can be readily separated from the remainder of the peel zone 37′ as a result of the longitudinally extending cut lines 28, 30 which define the individual strips.

Reference is now directed to FIG. 5 which shows an exemplary method of using the presently described invention. FIG. 5 provides a partial view of a patient's arm 50 to which an intravenous feed tube 51 has been connected. Removable strips 52, 52′ have been applied to the arm 50 to secure the tube 51 to the patient. In this example, the strips 52 and 52′ may be provided with removable or repositionable adhesive so that the strips may be readily removed from the patient at the end of the treatment or when changing IV bags. Strip 52″ secures the tube 51 to an IV bag 54, which may be for example accomplished through the use of a permanent adhesive so that the tube 51 does not separate from the bag 54.

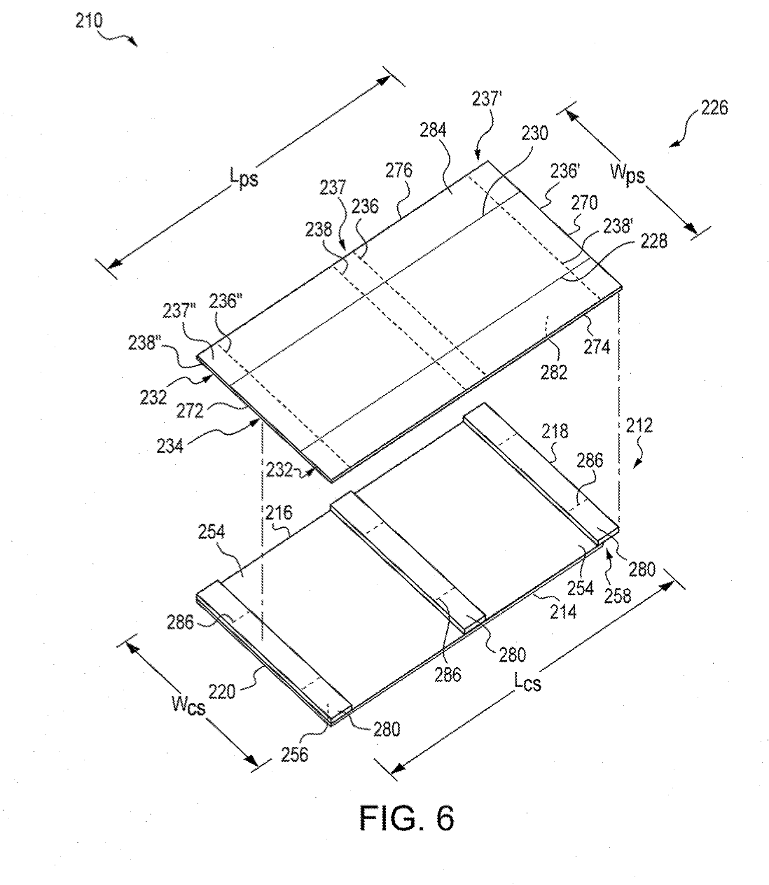

With reference to FIGS. 6 to 8, another preferred embodiment healthcare form assembly 210 is illustrated which includes a carrier sheet 212 and a printable sheet 226. The healthcare assembly 210 generally corresponds to the previously described healthcare assembly 10 illustrated in FIGS. 1 and 2, but includes three (3) peel zones and the incorporation of deadening material in each peel zone. Specifically, the healthcare assembly 210 is as follows. The carrier sheet 212 generally corresponds to the previously described quadrate sheet 12. And, the printable sheet 226 generally corresponds to the previously described printable sheet 26. The carrier sheet 212 and the printable sheet 226 can have similar shapes as will be discussed in more detail below. Further, the sizes of the carrier sheet 212 and the printable sheet 226 may be similar as will be described hereinafter.

The carrier sheet 212 defines a first face 254 that is directed toward the printable sheet 226 and a second face 256 that is directed away from the printable sheet 226. Thus, the second face 256 is oppositely directed from the first face 254. The carrier sheet 212 also includes a leading or first end edge 218 and a trailing or second end edge 220. The leading edge 218 and the trailing edge 220 are opposite one another and can be generally parallel to one another. The distance between the leading edge 218 and the trailing edge 220 defines the carrier sheet length L_{cs}.

With continued reference to FIG. 6, the carrier sheet 212 also includes a first side edge or first longitudinally extending side 214 and a second side edge or second longitudinally extending side 216. The first side edge 214 and the second side edge 216 can be generally parallel to one another and also generally perpendicular to the leading edge 218 and the trailing edge 220. The distance between the first side edge 214 and the second side edge 216 defines the carrier sheet width W_{cs}. The carrier sheet length L_{cs} is preferably greater than the carrier sheet width W_{cs}.

Further, the leading edge 218 of the carrier sheet 212, the trailing edge 220 of the carrier sheet 212, the first side edge 214 of the carrier sheet 212 and the second side edge 216 of the carrier sheet 212 cooperate to define a perimeter P_{cs} of the carrier sheet 212. The aforementioned shape of the carrier sheet 212 is beneficial for a number of reasons. For example, the rectangular shape of the carrier sheet 212 minimizes the amount of waste that is created during the manufacturing process since multiple carrier sheets can be cut from a larger master carrier sheet and minimal scrap pieces are created. Additionally, packaging of the healthcare form assembly 210 is simplified due to the fact that existing containers can be utilized to ship the assembly 210, thereby eliminating the need for a new container to be designed and manufactured.

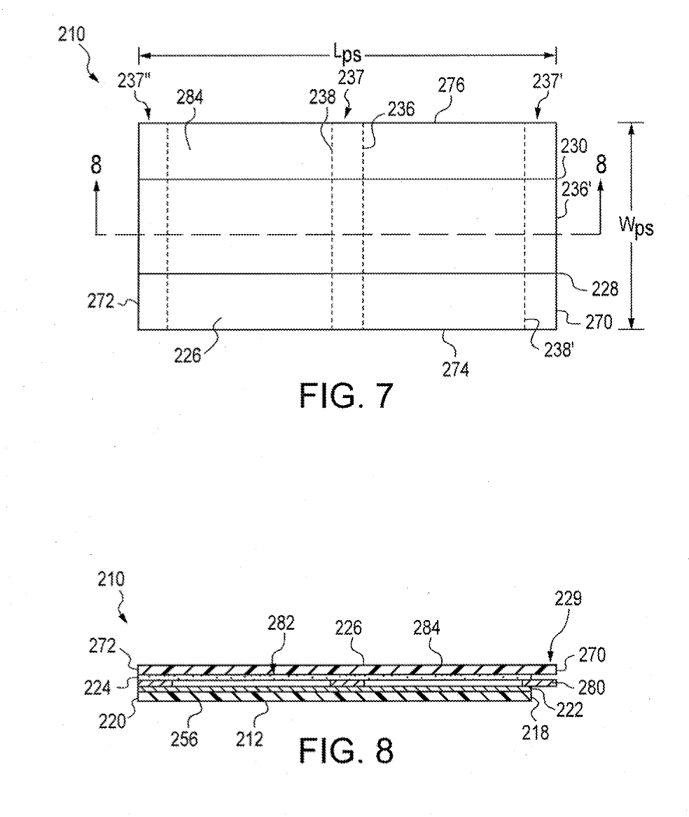

FIG. 7 is a top planar view of the healthcare assembly 210 of FIG. 6. FIG. 8 is a cross sectional view of the assembly 210 taken across line 8-8 in FIG. 7. As shown in FIG. 8, a release coating 222 is applied to the first face 254 of the carrier sheet 212. The release coating 222 can be of any number of formulations described in greater detail herein. The release coating 222 may be applied to the carrier sheet 212 in a solid or liquid format. The release coating 222 typically covers most or all of the first face 254 of the carrier sheet 212.

With continued reference to FIG. 8, an adhesive layer 224 is disposed adjacent to the release coating 222 of the carrier sheet 212. The adhesive layer 224 can be applied to a face or portion of the printable sheet 226, and specifically to the face of the printable sheet 226 directed toward the carrier sheet 212. The adhesive layer 224 may be applied in a pattern and may be of a reusable or permanent type adhesive. Alternatively, the adhesive layer 224 can be applied to the release coating 222 in a solid or liquid format.

With reference once again to FIG. 6, the printable sheet 226 can have a rectangular shape. However, the invention includes a wide array of other shapes. Further, the printable sheet 226 can be a same shape as the carrier sheet 212. As illustrated, the printable sheet 226 is removably and releasably disposed on the carrier sheet 212. The printable sheet 226 includes a leading edge 270 and a trailing edge 272 that are opposite one another and generally parallel to one another. The distance between the leading edge 270 and the trailing edge 272 defines the printable sheet length Lₚₛ.

As shown in FIG. 7, the printable sheet 226 also includes a first side edge 274 and a second side edge 276. The first side edge 274 and the second side edge 276 can be generally parallel to one another and generally perpendicular to the leading edge 270 and the trailing edge 272. The distance between the first side edge 274 and the second side edge 276 defines the printable sheet width Wₚₛ. The printable sheet length Lₚₛ is preferably greater than the printable sheet width Wₚₛ.

The trailing edge 272 of the printable sheet 226, the first side edge 274 of the printable sheet 226, the leading edge 270 of the printable sheet 226, and the second side edge 276 of the printable sheet 226 cooperate to define a perimeter Pₚₛ of the printable sheet 226. Preferably, for rectangular or square shaped printable sheets 226, a summation of two times the length Lₚₛ and two times the width Wₚₛ equals a perimeter Pₚₛ of the printable sheet 226. Further for rectangular or square shaped printable sheets 226, an area Aₚₛ of the printable sheet 226 is defined by the product of the length Lₚₛ and the width Wₚₛ.

With further reference to FIGS. 6-8, the printable sheet 226 also includes an inner face 282 and an outer face 284. The inner face 282 is directed toward the first face 254 of the carrier sheet 212 and the outer face 284 is oppositely directed from the inner face 282 and faces away from the carrier sheet 212. The outer face 284 can include indicia such as for example indicia 11, 13 as shown in FIG. 1.

With continued reference to FIG. 6, the printable sheet 226 also defines a first set of cut lines 236, 238. The first set of cut lines 236, 238 extend substantially parallel to the leading edge 270 of the printable sheet 226 to create a first peel zone 237. Preferably, the peel zone 237 is defined generally proximate the midsection of the printable sheet 226 and most preferably oriented to extend collinearly with a line bisecting the printable sheet 226 into two halves of equal area. The printable sheet 226 also defines a second set of cut lines 236′, 238′ that extend substantially parallel to and alongside the leading edge 270 of the printable sheet 226 to create a second peel zone 237′. And, the printable sheet 226 also defines a third set of cut lines 236″, 238″ that extend substantially parallel to and alongside the trailing edge 272 of the printable sheet 226 to create a third peel zone 237″.

The printable sheet 226 also defines at least one longitudinal cut line 228, 230 that extends between the leading edge 270 of the printable sheet 226 and the trailing edge 272 of the printable sheet 226 so as to create a plurality of strips 232, 234. The longitudinal cut lines 228, 230 are generally parallel to the first side edge 274 and are spaced from the first side edge 274 of the printable sheet 226 such that the strips 232, 234 are of unequal width. However, it will be appreciated that the cut lines 228, 230 could be located along the printable sheet 226 so as to define strips of equal width. As described hereinbefore, these strips 232, 234 can be used to affix various medical products to patients or to other medical components.

With further reference to FIGS. 6 and 8, the healthcare form assembly 210 preferably includes deadening material 280 disposed between the carrier sheet 212 and the printable sheet 226 and specifically, between the adhesive layer 224 and the release coating 222, as shown in FIG. 8. The deadening material 280 is preferably disposed in the peel zones 237, 237′, and 237″. The deadening material 280 extends between the first side 214 and the second side 216 of the carrier sheet 212. The deadening material 280 can be rectangular in shape and prevents at least a portion of the adhesive layer 224 from adhering to select regions of the carrier sheet 212, and specifically, the release coating 222 disposed on the carrier sheet 212. Furthermore, regions of the adhesive layer 224 in contact with the deadening material 280 also serve to adhere or retain the deadening material to the printable sheet 226 and specifically to the inner face 282 of the printable sheet 226. FIG. 8 illustrates provision of fingerlifts 229 which comprise regions of both the printable sheet 226 and the deadening material 280 extending beyond the leading edge 218 of the carrier sheet 212.

Preferably, strips of deadening material 280 are disposed within each of the peel zones. However, the invention includes providing one or more peel zones free of deadening material. The peel zones which are free of deadening material can utilize other provisions for promoting separation of a region of the printable sheet 226 from the carrier sheet 212 such as making such area free of adhesive or deadening any adhesive in the particular peel zone as previously noted in conjunction with the description of the healthcare assembly 10. Furthermore, it is also contemplated that for a peel zone including a strip or section of a deadening material, that the deadening material need not cover or extend within the entire peel zone.

Referring again to FIG. 6, the deadening material 280 preferably defines at least one longitudinal cut line 286 that extends in a direction generally parallel to the first side edge 214 of the carrier sheet 212. Further, the at least one longitudinal cut line 286 of the deadening material 280 and the at least one longitudinal cut line 228, 230 of the printable sheet 226 are substantially aligned and coplanar in a plane generally perpendicular to the first face 254 of the carrier sheet 212. Since the at least one longitudinal cut line 286 of the deadening material 280 and the at least one longitudinal cut line 228, 230 of the printable sheet 226 are substantially aligned and coplanar, strips from the printable sheet 226 can more easily be removed from the carrier sheet 212. This results in a healthcare form assembly 210 that can be quickly and efficiently used on a patient as will be described in more detail hereinafter.

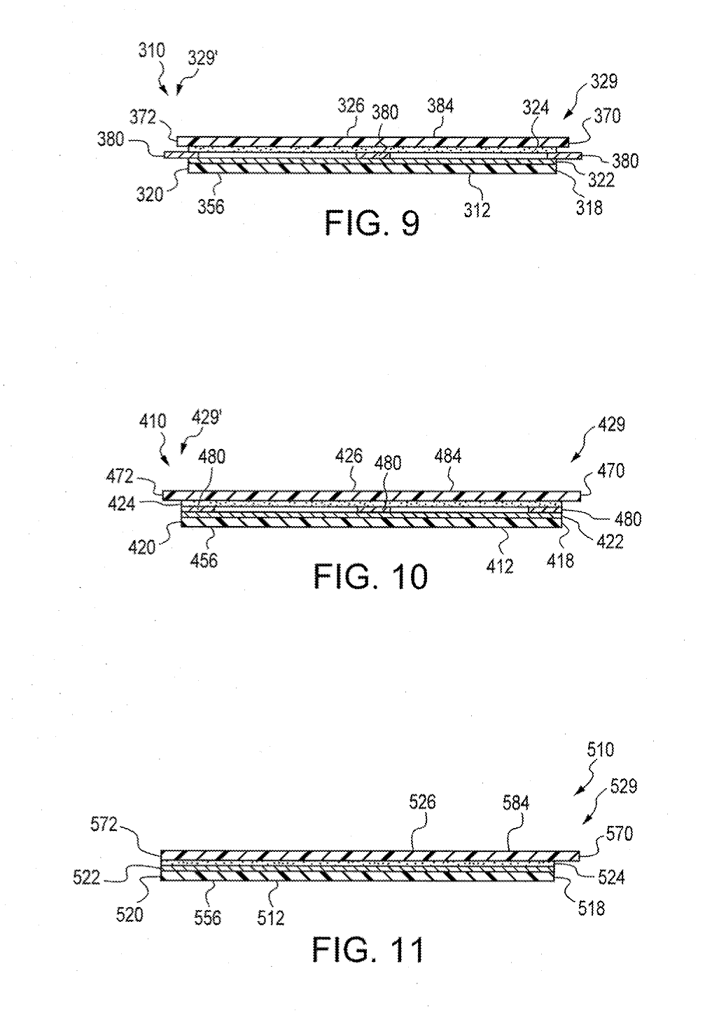

The present invention includes a wide array of peel zones, fingerlifts, and configurations for promoting separation of a removable adhesive strip from a carrier sheet in a healthcare assembly. As shown in FIG. 9, in certain embodiments at least a portion of the deadening material and the printable sheet extend beyond the leading edge of the carrier sheet, however their outer edges need not be aligned as in the embodiment depicted in FIG. 8. Specifically, FIG. 9 illustrates an alternate preferred embodiment healthcare assembly 310 having portions of deadening material 380 extending laterally outward beyond an edge 318 of a carrier sheet 312. Specifically, a fingerlift 329 is formed adjacent the edge 318 of the carrier sheet 312 by the regions of outwardly extending deadening material 380 and a portion of a printable sheet 326 which extend beyond the edge 318 of the carrier sheet 312. In this embodiment 310, a similar fingerlift 329′ is provided adjacent an opposite edge 320 of the carrier sheet 312.

The invention also includes versions of the healthcare assembly in which both regions of the printable sheet and regions of deadening material extend beyond an outer edge of a carrier sheet, and further in which the region of outwardly extending printable sheet extends beyond an outer edge of the deadening material. Moreover, it is contemplated that this configuration could be provided at all or in less than all peel zones defined along a peripheral edge of a healthcare assembly.

As previously described and shown in FIGS. 8 and 9, in certain embodiments at least a portion of the leading edge of the printable sheet extends beyond the leading edge of the carrier sheet. Thus, for example in FIG. 9, the leading edge 370 of the printable sheet 326 extends beyond the leading edge 318 of the carrier sheet 312. In such embodiments, typically the printable sheet length Lₚₛ is greater than the carrier sheet length L_{cs}. Furthermore, in such embodiments, the area Aₚₛ of the printable sheet is greater than the area A_{cs} of the carrier sheet and the printable sheet perimeter Pₚₛ is greater than the carrier sheet perimeter P_{cs}.

FIG. 10 is a cross sectional view of yet another preferred embodiment healthcare assembly 410 in accordance with the invention. In this embodiment, fingerlifts 429 and 429′ are provided by only a region of a printable sheet 426 and specifically edges 470 and 472, extending beyond edges 418 and 420 of a carrier sheet 412. Thus, in this embodiment, outer edges of a deadening material 480 are aligned with the edges 418 and 420 of the carrier sheet 412, and do not extend outward past the edges 418 and 420.

The invention includes embodiments in which only a single fingerlift of the configuration depicted in FIG. 10 is provided along a peripheral edge of a healthcare assembly. This embodiment may be preferred for versions of the healthcare assembly in which relatively long removable strips are provided that extend along an entire length or width of the assembly. Thus, typically only a single peel zone is needed.

Referring to FIG. 11, another preferred embodiment healthcare assembly 510 is shown having at least one fingerlift 529 along a peripheral region of the assembly 510. In this embodiment, the assembly 510 is free of strips or sections of deadening material. This embodiment may be preferred for low cost versions of the invention yet which include one or more fingerlifts. Referring further to FIG. 11, when a printable sheet 526 is disposed on a carrier sheet 512 and a trailing edge 572 of the printable sheet 526 is aligned with a trailing edge 520 of the carrier sheet 512, a leading edge 570 of the printable sheet 526 is spaced from the trailing edge 520 of the carrier sheet 512 a distance that is greater than a distance between the leading edge 518 of the carrier sheet 512 and the trailing edge 520 of the carrier sheet 512. More particularly, when the trailing edge 572 of the printable sheet 526 is aligned with the trailing edge 520 of the carrier sheet 512, the respective trailing edges 572, 520 are substantially coplanar in a plane generally perpendicular to a face 556 of the carrier sheet 512.

In certain embodiments as shown in FIGS. 9 and 10, the leading and trailing edges of the printable sheet extend beyond the leading and trailing edges of the carrier sheet. Thus in FIG. 9 for example, the leading and trailing edges 370, 372 of the printable sheet 326 extend beyond the leading and trailing edges 318, 320 of the carrier sheet 312. Further, as illustrated in FIG. 9, the deadening material 380 extends beyond the leading and trailing edges 318, 320 of the carrier sheet 312. With the configuration illustrated in these figures, the strips can be easily and quickly removed from either end of the carrier sheet.

In all of the noted embodiments, the carrier sheet can be comprised of paper, polymer film, or a combination thereof. The carrier sheet may be transparent to permit visibility of the printable sheet through the carrier sheet, as well as through other layers between the carrier sheet and the pintable sheet. Thus, the use of transparent polymer films as the carrier sheet is contemplated. In other embodiments, the carrier sheet may be opaque or comprise one or more coloring agents such as whitening agents or pigments. Translucent carrier sheets are also contemplated. The outer surface or underside of the carrier sheet may have a release coating adhered to it to facilitate stacking of the products. Any release coating known in the art can be used. Silicone release coatings are especially useful. Untreated polyester film can be used. The carrier sheet typically has a thickness of from about 6.4 microns (about 0.25 mils) to about 2.5 microns (about 0.1 mils), and in one embodiment about 13 microns (about 0.5 mils) 0.5 to about 125 microns (about 5 mils), and in one embodiment about 50 microns (about 2 mils).

Pressure sensitive adhesives suitable for use with the present invention include permanent, removable, repositionable or other adhesives or combinations thereof that may meet the particular needs of the end use application. For example, a removable adhesive may be used to secure a section of medical tubing to a patient's arm such as with an intravenous (IV) tube. It should be understood that the assembly can be provided with a single type of adhesive, or alternatively, different types of adhesive can be applied to the form in order to serve different functions. For example, certain removable strips (which will be described herein) can be provided with a permanent adhesive and other types of removable strips can be provided with a removable adhesive.

The printable sheet can be comprised of paper, polymer film, fibrous materials, or combinations thereof. A preferred material for use as the printable sheet is a nonwoven material. Medical grade nonwoven materials are well known in the art and commercially available from a wide array of suppliers. The printable sheet can be coated selectively with a print binder material such as polyvinyl alcohol to help the toner or ink adhere to the surface of the sheet. In addition, the entire assembly can be coated or provided with an antimicrobial material to reduce potential contamination.

The deadening material, if used, can be comprised of paper, polymer film, fibrous materials, or combinations thereof. Preferably, the deadening material is formed from the same material as the printable sheet, and thus is preferably a nonwoven material.

In certain embodiments, due to the size and orientation of the printable sheet as compared to the carrier sheet, numerous benefits are provided by the healthcare form assembly. For example, the printable sheet is more easily separated from the carrier sheet than if the printable sheet and the carrier sheet were the same size. This is especially helpful when the healthcare provider completing this task is wearing surgical gloves. Specifically, since the healthcare provider is able to separate the printable sheet from the carrier sheet without removing their gloves, the risk that the healthcare provider is exposed to harmful pathogens is reduced.

Another advantage of the size and orientation of the printable sheet is as follows. In emergency medical situations, time can be of the essence. Accordingly, it is desirable that any medical product be able to be used on the medical patient in a rapid manner. In certain embodiments, because of the size and orientation of the printable sheet as compared to the carrier sheet, the printable sheet can rapidly be removed from the carrier sheet and used on the patient with a minimum amount of delay.

The aforementioned size and orientation of the printable sheet with respect to the carrier sheet allows the healthcare assembly form to be used in a variety of environments where a traditional healthcare assembly form could not be used. In particular, the leading edge provides tactile feedback to the healthcare provider, thereby allowing the healthcare assembly form to be used when visibility is decreased. As can be appreciated, there are numerous instances where there is decreased visibility, including for example low light environments in military field hospitals or in ambulance type vehicles. It will thus be seen according to the present invention a highly advantageous healthcare assembly has been provided.

While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. A healthcare form assembly comprising:
a carrier sheet defining a leading edge and an oppositely disposed trailing edge;
a release coating disposed on the carrier sheet;
an adhesive layer disposed on the release coating;
a printable sheet having a same or substantially the same shape as the carrier sheet and being removably disposed on the carrier sheet, the printable sheet defining a leading edge and an oppositely disposed trailing edge, the printable sheet oriented on the carrier sheet such that the trailing edge of the printable sheet is intimately disposed next to the trailing edge of the carrier sheet, the printable sheet also defining a first set of cut lines, and another set of transversely extending cut lines extending substantially parallel to the leading edge of the printable sheet to thereby create a first peel zone along the leading edge of the printable sheet;
the healthcare form assembly also comprising a strip or section of a layer of a deadening material disposed in the first peel zone.

2. The healthcare form assembly of claim 1 wherein the printable sheet defines another set of transversely extending cut lines extending substantially parallel to the leading edge of the printable sheet and spaced from the first peel zone to thereby create a second peel zone.

3. The healthcare form assembly of claim 2 further comprising another strip or section of a layer of a deadening material disposed in the second peel zone.

4. The healthcare form assembly of claim 1 wherein the strip or section of the layer of the deadening material is disposed between the release coating and the adhesive layer.

5. The healthcare form assembly of claim 2 wherein the first peel zone is defined along the trailing edge of the printable sheet and the second peel zone is defined along the trailing edge of the printable sheet.

6. The healthcare form assembly of claim 2 wherein the printable sheet defines another set of transversely extending cut lines extending substantially parallel to the leading edge of the printable sheet and spaced from the first peel zone and the second peel zone to thereby create a third peel zone.

7. The healthcare form assembly of claim 6 further comprises another strip or section of a layer of a deadening material disposed in the third peel zone.

8. A healthcare form assembly comprising:
a carrier sheet defining a leading edge and a trailing edge which are generally parallel to one another, and a first side edge and a second side edge that are generally perpendicular to the leading edge;
a release layer disposed on the carrier sheet;
an adhesive layer disposed on the release layer;
a printable sheet releasably disposed on the carrier sheet, the printable sheet defining a leading edge and a trailing edge which are generally parallel to one another, and a first side edge and a second side edge that are generally perpendicular to the leading edge of the printable sheet;
wherein the printable sheet defines a collection of cut lines extending substantially parallel to one of the first side edge and the second side edge of the printable sheet, thereby defining a plurality of removable adhesive strips, the printable sheet also defining a first set of cut lines extending substantially parallel to the leading edge of the printable sheet to thereby create a first peel zone along the leading edge of the printable sheet and a second set of cut lines extending substantially parallel to the leading edge of the printable sheet to thereby create a second peel zone spaced from the first peel zone; and
the healthcare form assembly also comprising at least one section of a layer of deadening material disposed in at least one of the first and second peel zones.

9. The healthcare form assembly of claim 8 wherein the distance between the leading edge of the carrier sheet and the trailing edge of the carrier sheet defines a carrier sheet length, the distance between the first side edge of the carrier sheet and the second side edge of the carrier sheet defines a carrier sheet width, and the carrier sheet length is greater than the carrier sheet width.

10. The healthcare form assembly of claim 8 wherein the distance between the leading edge of the printable sheet and the trailing edge of the printable sheet defines a printable sheet length, the distance between the first side edge of the printable sheet and the second side edge of the printable sheet defines a printable sheet width, and the printable sheet length is greater than the printable sheet width.

11. The healthcare form assembly of claim 8 wherein the section of the layer of deadening material is disposed in the first peel zone.

12. The healthcare form assembly of claim 11 wherein at least a portion of at least one of (i) the layer of deadening material and (ii) the printable sheet extends beyond the leading edge of the carrier sheet.

13. The healthcare form assembly of claim 8 wherein the second peel zone includes a bisecting cut line defined in the printable sheet.

14. The healthcare form assembly of claim 8 wherein the first peel zone is defined along a peripheral region of the assembly and the second peel zone is defined within a midsection of the assembly.

15. The healthcare form assembly of claim 8 wherein the printable sheet defines a third set of cut lines extending substantially parallel to the leading edge of the printable sheet to thereby create a third peel zone which is spaced from the first peel zone and the second peel zone.

16. The healthcare form assembly of claim 15 wherein the first peel zone is defined along the leading edge of the printable sheet, the third peel zone is defined along the trailing edge of the printable sheet, and the second peel zone is defined between the first and third peel zones and oriented substantially parallel thereto.

17. The healthcare form assembly of claim 8 wherein the release layer and the adhesive layer are disposed between the carrier sheet and the printable sheet, and the layer of deadening material is disposed between the adhesive layer and the release layer.
